(19) United States
(12) Patent Application Publication
(10) Pub. No.: US 2026/0064108 A1
(43) Pub. Date: Mar. 5, 2026

(54) INSPECTION APPARATUS

(71) Applicant: TOYOTA BOSHOKU KABUSHIKI KAISHA, Aichi-ken (JP)

(72) Inventor: Junji HATTORI, Kariya-shi (JP)

(73) Assignee: TOYOTA BOSHOKU KABUSHIKI KAISHA, Aichi-ken (JP)

(21) Appl. No.: 19/126,726

(22) PCT Filed: Oct. 31, 2023
(86) PCT No.: PCT/JP2023/039190

§ 371 Date: May 2, 2025

(30) Foreign Application Priority Data
Nov. 15, 2022 (JP) 2022-182581

(51) Int. Cl. G05B 23/02; G06T 7/00

(52) U.S. Cl. CPC G05B 23/0254; G05B 23/027; G06T 7/0004

(57) ABSTRACT

An inspection apparatus (10) includes an image capturing device (20), a memory module (32), a determination unit (33), and a notification unit (40). The image capturing device (20) is configured to capture images of a work area. The memory module (32) stores a first learning model (M1) trained through machine learning to output, when receiving image data captured by the image capturing device (20), an indicator that indicates whether an assembly state of a component is a correct assembly state. The determination unit (33) is configured to determine whether the assembly state is the correct assembly state for each assembly step based on an output result of the first learning model (M1). The notification unit (40) is configured to notify an operator of a determination result of the determination unit (33).

### TECHNICAL FIELD

The present disclosure relates to an inspection apparatus.

### BACKGROUND ART

Patent Literature 1 discloses an incorrect/missing component checking apparatus (hereinafter, referred to as a checking apparatus) that inspects whether regular components are correctly assembled in a product manufacturing site.

The checking apparatus includes an image display device that selectively displays multiple component images including regular components and dummy components from among a large number of component images.

During an assembly operation using the checking apparatus, the operator, after assembling regular components, selects the images of the assembled components from among the multiple component images displayed on the image display device. If the assembly sequence for multiple regular components is predetermined, the operator selects the component images in accordance with the specified assembly sequence. When the operator selects the images of the regular components assembled by the operator, the image display device indicates on the screen that the regular components have been assembled. This allows the operator to recognize that the process can proceed to the next step.

### CITATION LIST

### Patent Literature

Patent Literature 1: Japanese Laid-Open Patent Publication No. 2003-316420

### SUMMARY OF INVENTION

### Technical Problem

In the checking apparatus described in Patent Literature 1, the operator must select component images on the image display device each time components are assembled. This selection process interrupts the operator's assembly operation, and thus may reduce the production efficiency.

### Solution to Problem

In accordance with one aspect of the present disclosure, an inspection apparatus is configured to inspect a sequence of operations during manufacturing of a product that is manufactured by an operator assembling multiple types of components. The inspection apparatus includes an image capturing device configured to capture an image of a work area where the components are assembled, a memory module storing a learning model that is trained through machine learning to output, when receiving image data captured by the image capturing device, an indicator that indicates whether an assembly state of the components is a correct assembly state, a determination unit configured to determine whether the assembly state is the correct assembly state for each assembly step based on an output result of the learning model, and a notification unit configured to notify the operator of a determination result of the determination unit.

### BRIEF DESCRIPTION OF DRAWINGS

FIG. 1 is a schematic diagram illustrating a general configuration of an inspection apparatus according to an embodiment.

FIG. 2 is a block diagram showing a configuration of the inspection apparatus shown in FIG. 1.

FIG. 3 is an exploded perspective view of an air cleaner inspected by the inspection apparatus shown in FIG. 1.

FIG. 4 is a plan view of component boxes that accommodate components of the air cleaner shown in FIG. 3.

FIG. 5 is a flowchart showing an inspection process.

FIG. 6 is a flowchart showing a preparation determination process.

FIG. 7 is a flowchart showing an assembly sequence determination process.

### DESCRIPTION OF EMBODIMENTS

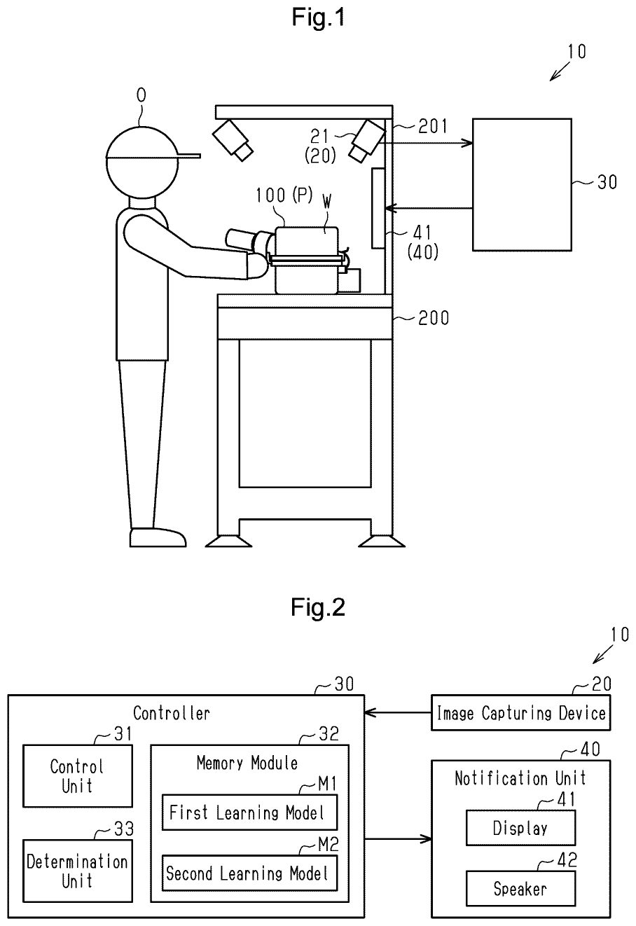

An inspection apparatus according to an embodiment will now be described with reference to FIGS. 1 to 7.

### Inspection Apparatus 10

As shown in FIG. 1, an inspection apparatus 10 inspects a sequence of operations during the manufacturing of a product P, which is manufactured by an operator O assembling multiple types of components W. The inspection apparatus 10 is provided on a workbench 200, on which the operator O performs an assembly operation.

As shown in FIGS. 1 and 2, the inspection apparatus 10 includes an image capturing device 20, a controller 30, and a notification unit 40. The image capturing device 20 captures images of the workbench 200, that is, a work area in which the operator O performs the assembly operation. The controller 30 determines the correctness of the assembly sequence (hereinafter simply referred to as the “assembly sequence”) based on the image data captured by the image capturing device 20. The notification unit 40 notifies the operator O of the result of the correctness determination of the assembly sequence performed by the controller 30.

Next, the configuration of an air cleaner 100, which is an example of the product P, will be described.

### Air Cleaner 100

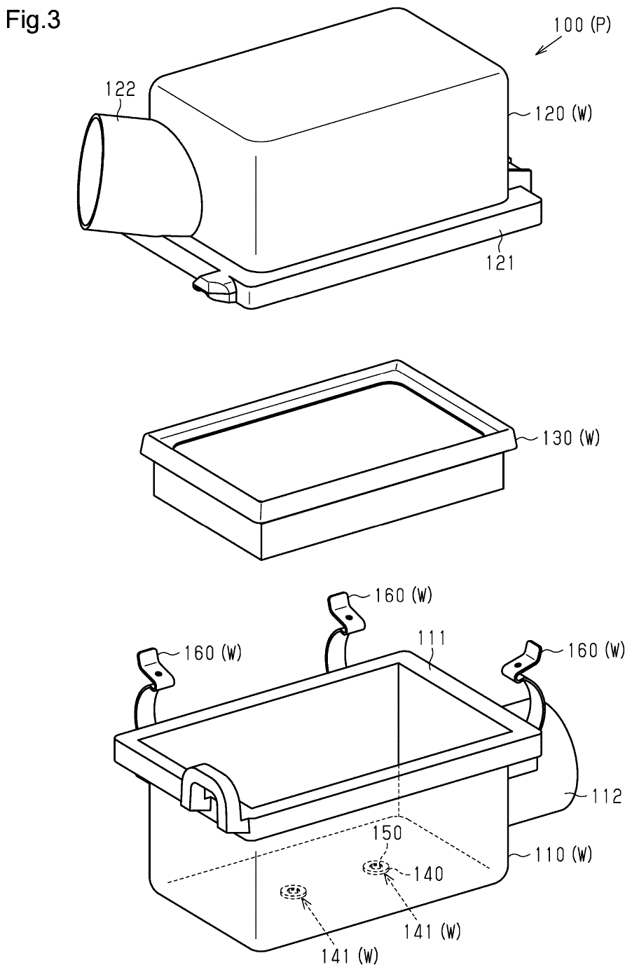

As shown in FIG. 3, the air cleaner 100 includes a case 110, a cap 120, a filter element 130, multiple grommets 140, multiple collars 150, and multiple clamps 160. The air cleaner 100 includes, for example, two grommets 140, two collars 150, and three clamps 160.

The case 110, the cap 120, the filter element 130, the grommets 140, the collars 150, and the clamps 160, which are components of the air cleaner 100, are each an example of a “component.” Hereinafter, the component of the air cleaner 100 may be referred to as components W.

The case 110 has the shape of a box having an upper opening. The case 110 has a first flange 111, which protrudes outward from the peripheral edge of the upper opening and extends over the entire periphery of the upper opening. The case 110 has a tubular inlet 112 in a peripheral wall.

The cap 120 has the shape of a box having a lower opening. The cap 120 has a second flange 121, which protrudes outward from the peripheral edge of the lower opening and extends over the entire periphery of the lower opening. The cap 120 has a tubular outlet 122 in a peripheral wall.

The filter element 130 is provided between the case 110 and the cap 120. The filter element 130 is held between the first flange 111 and the second flange 121.

Each grommet 140 has a cylindrical shape. The two grommets 140 are respectively attached to two through-holes (not shown) formed in the bottom wall of the case 110.

Each collar 150 has a cylindrical shape. The two collars 150 are press-fitted into the two grommets 140, respectively.

The three clamps 160 are attached to the peripheral wall of the case 110 at intervals. Each clamp 160 is configured to be rotatable with respect to the case 110 so as to approach and separate from the cap 120. The clamps 160 are engaged with the cap 120, so that the cap 120 is fixed to the case 110.

In a state in which the cap 120 is fixed to the case 110, the filter element 130 is not visible from the outside of the air cleaner 100.

The air cleaner 100 is available in multiple product variants, with differences in the shape and the number of the components W.

### Assembly Sequence of the Air Cleaner 100

During the manufacturing process of the air cleaner 100, the operator O performs a preparation operation for preparing the components W and an assembly operation for assembling the components W.

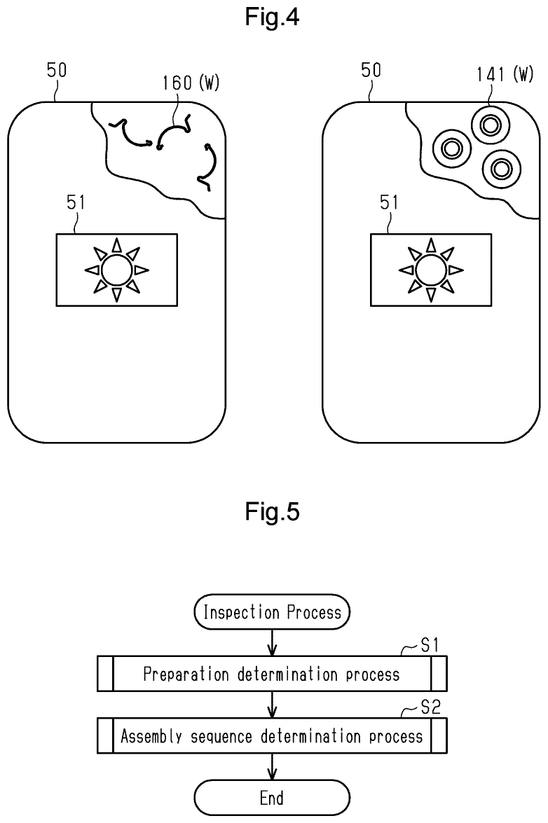

As shown in FIG. 4, in the preparation operation, the operator O prepares component boxes 50, which accommodate the components W. When multiple types of components W are used, each type is stored in a different component box 50.

In the present embodiment, grommets 140 into which collars 150 are press-fitted in advance, and clamps 160 are stored separately in different component boxes 50.

Hereinafter, the grommets 140 with the press-fitted collars 150 are referred to as collar-integrated grommets 141.

Each component box 50 includes a display section 51, which shows information on the variant of the product P. As the display section 51, for example, a mark, a figure, a symbol, a character, and a two-dimensional code can be used. In the present embodiment, the display section 51 is a mark that is set in accordance with the variant of the product P.

In a case in which a component W is used in common for multiple variants of products P, the component box 50 that accommodates that component W may include multiple display sections 51 that respectively show information related to the multiple product variants.

In the assembly operation, the operator O takes out a component W from a component box 50 and assembles the component W to another component W. In the present embodiment, the operator O takes out the collar-integrated grommets 141 and the clamps 160 from the component boxes 50 and assembles them onto the case 110.

Specifically, first, the operator O assembles the collar-integrated grommets 141 onto the case 110. Next, the operator O assembles the clamps 160 onto the case 110. Then, the operator O places the filter element 130 between the case 110 and the cap 120. Finally, the operator O fixes the cap 120 to the case 110 using the clamps 160.

### Image Capturing Device 20

As shown in FIG. 1, the image capturing device 20 includes multiple cameras 21 that capture images of the work area from different angles. The image capturing device 20 includes four cameras 21 respectively fixed to a frame 201 extending upward from the workbench 200. For example, the four cameras 21 are respectively fixed to the frame 201 above four corners of the workbench 200, which has a rectangular shape in plan view.

The image data obtained by the image capturing device 20 capturing images of the work area is acquired by the controller 30. The image data may be video data or still image data. In the present embodiment, the image data is video data.

### Controller 30

As shown in FIG. 2, the controller 30 includes a control unit 31, a memory module 32, and a determination unit 33.

The control unit 31 includes an arithmetic processing unit such as a CPU, an MPU, or a GPU. The control unit 31 executes various kinds of information processing, control processing, and the like by reading and executing programs stored in the memory module 32. The memory module 32 includes memory devices such as a RAM and a ROM. The memory module 32 stores programs necessary for the control unit 31 to execute various kinds of arithmetic processing. The memory module 32 temporarily stores data and the like necessary for the control unit 31 to execute various kinds of arithmetic processing.

The memory module 32 stores a first learning model M1 and a second learning model M2. The first learning model M1 is trained through machine learning to output, when receiving image data including a component W, an indicator that indicates whether the assembly state of the component W is a correct assembly state. The second learning model M2 is trained through machine learning to output, when receiving image data including a display section 51, an indicator that indicates which of multiple variants of the product P is the product variant information shown on the display section 51.

The first learning model M1 and the second learning model M2 receive captured image data as input and output indicators indicating whether objects contained in the image data correspond to predetermined classes. In the first learning model M1, the classes are defined as the correct assembly states for each assembly step of the assembly operation. In the second learning model M2, the classes are defined as multiple types of the display sections 51, each corresponding to different product variants.

The indicators output by the first learning model M1 and the second learning model M2 represent, for example, the probability that an object contained in the image data belongs to a given class. Accordingly, the first learning model M1 receives image data as input and outputs a probability indicating whether the assembly state of a components W is the correct assembly state. Similarly, the second learning model M2 receives image data as input and outputs a probability indicating which of the multiple types of display sections 51 is present in the image data.

The first learning model M1 and the second learning model M2 are generated through machine learning using, for example, a deep neural network (DNN). Examples of machine learning algorithms that may be employed include a Region-Based Convolutional Neural Network (R-CNN), a Single Shot Multibox Detector (SSD), and You Only Look Once (YOLO).

The first learning model M1 is trained through machine learning using training data, in which images of the components W assembled in the correct assembly state are labeled with information indicating the correct assembly state. The images in the training data for the first learning model M1 may include the body of the operator O during the assembly operation.

In order to enhance the versatility of the first learning model M1, it is preferable to use training data acquired under various conditions. For example, in consideration of the habits of the operator O during the assembly operation, it is preferable to use training data in which the above labels are attached to images of the components W captured when different operators O perform the assembly operation.

The second learning model M2 is trained through machine learning using training data, in which each image of the multiple types of display sections 51 is labeled with information indicating its own type.

The determination unit 33 determines whether the assembly state of the components W in the image data is the correct assembly state for each assembly step based on the output result of the first learning model M1.

The correct assembly state refers to a state in which the relative positions and the number of the assembled components W are correct.

The determination unit 33 determines that the assembly state is the correct assembly state when the probability output by the first learning model M1, indicating that the assembly state of the components W is correct, is greater than or equal to a threshold.

In a case in which the components W are assembled in the correct assembly state, depending on the orientations of the components W, it may be possible to determine that the components W are in the correct assembly state only from the image data of one of the multiple cameras 21. In this case, the first learning model M1 receives, as input, the image data captured by that one camera 21 and outputs an indicator indicating that the assembly state of the components W is the correct assembly state. The determination unit 33 then determines, based on this output, that the assembly state of the components W is correct. That is, the determination unit 33 determines that the assembly state of the components W is correct when the output result of the first learning model M1 having received, as input, image data captured by at least one of the cameras 21, is an indicator indicating the correct assembly state.

The determination unit 33 determines, based on the image data of the display section 51 captured by the image capturing device 20, whether the variant of the product P shown on the display section 51 matches a manufacturing variant V, which is the variant of the product P being manufactured by the operator O. Specifically, the determination unit 33 determines whether the product variant shown on the display section 51 in the image data and the manufacturing variant V match based on the output result of the second learning model M2. In addition, the determination unit 33 determines, based on the image data, whether the number of the component boxes 50, each having the display section 51 that shows the manufacturing variant V, matches the number of types of the components W that are to be accommodated in the component boxes 50 among components W of multiple types.

When the probability output by the second learning model M2, indicating that a display section 51 shows the manufacturing variant V, is greater than or equal to the predetermined threshold, the determination unit 33 determines that the display section 51 shows the manufacturing variant V.

### Notification Unit 40

The notification unit 40 includes, for example, a display 41 and a speaker 42. The display 41 is disposed at a position where the operator O can visually recognize the display 41. The display 41 is fixed to, for example, a portion of the frame 201 that is located in front of the operator O (see FIG. 1). The speaker 42 is integrated with the display 41, for example.

The display 41 presents information such as the assembly task for each assembly step and the progress of each assembly step.

The notification unit 40 notifies the operator O of the determination result of the determination unit 33. Specifically, the notification unit 40 notifies the operator O whether the preparation operation has been performed correctly and whether the assembly sequence is correct. The notification unit 40 notifies the operator O, for example, whether the assembly sequence is correct for each assembly step.

The display 41 presents the determination result of the determination unit 33 in text form. The speaker 42, for example, generates a predetermined sound corresponding to the determination result output by the determination unit 33.

### Inspection Process

Next, a procedure of an inspection process performed by the inspection apparatus 10 will be described with reference to FIGS. 5 to 7. The inspection process is performed when the manufacturing variant V is registered in the controller 30 in advance.

As illustrated in FIG. 5, first, the inspection apparatus 10 performs a preparation determination process of determining whether the components W used in the product P are correctly prepared (step S1). Prior to the preparation determination process, the component boxes 50 are placed on the workbench 200 by the operator O.

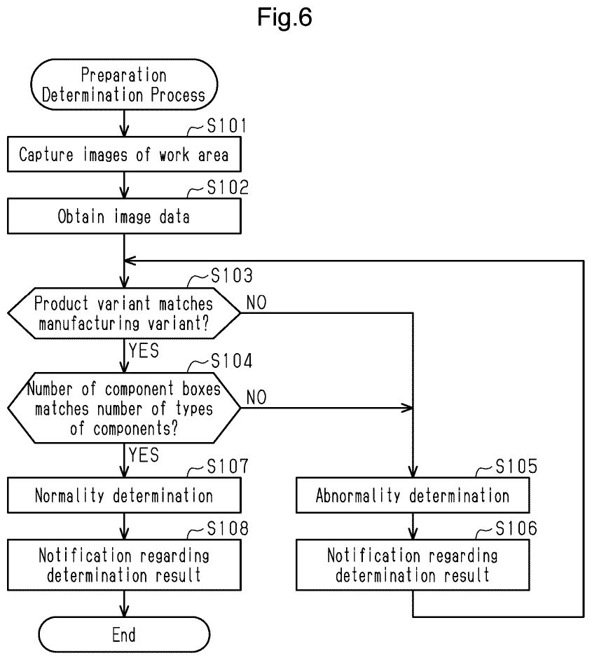

As illustrated in FIG. 6, in the preparation determination process, first, the image capturing device 20 captures images of the work area of the workbench 200 (step S101). The image capturing device 20 continues capturing images of the work area until the inspection process ends.

Next, the controller 30 acquires the image data captured by each camera 21 of the image capturing device 20 (step S102). The controller 30 performs image processing on the image data.

Next, the controller 30 determines whether the product variant shown on the display sections 51 of the component boxes 50 in the image data match the manufacturing variant V (step S103). Specifically, the controller 30 determines whether the display sections 51 in the image data is the display sections 51 that show the manufacturing variant V.

In a case in which the product variant shown on the display sections 51 and the manufacturing variant V match (step S103: YES), the controller 30 determines whether the number of component boxes 50 including the display sections 51 showing the manufacturing variant V and the number of types of the components W that are to be accommodated in the component boxes 50 match (step S104). In a case in which the types shown on the display sections 51 and the manufacturing variant V do not match (step S103: NO), that is, in a case in which the regular component boxes 50 are not prepared, the controller 30 determines that the preparation operation was not correctly performed (step S105). The number of types of the components W accommodated in the component boxes 50 varies depending on the variant of the product P. Since the manufacturing variant V is registered in the controller 30 in advance, the controller 30 holds information on the number of types of the components W accommodated in the component boxes 50.

In the present embodiment, the collar-integrated grommets 141 and the clamps 160 are respectively accommodated in two component boxes 50. Therefore, the number of types of the components W accommodated in the component boxes 50 is two. For this reason, in step S104, the controller 30 determines whether the number of the component boxes 50 having the display sections 51 showing the manufacturing variant V is two.

In step S104, in a case in which the number of the component boxes 50 and the number of types of the components W match (step S104: YES), the controller 30 determines that the preparation operation has been correctly performed (step S107). In contrast, in a case in which the number of the component boxes 50 and the number of types of the components W do not match (step S104: NO), that is, in a case in which the number of the component boxes 50 is insufficient, the controller 30 determines that the preparation operation has not been correctly performed (step S105).

When the process of step S105 is executed, the notification unit 40 issues a notification regarding the determination result of the controller 30 (step S 106). In step S106, the notification unit 40 causes the display 41 to display that the determination result of the controller 30 is the abnormality determination, that is, that the preparation operation has not been correctly performed, and causes the speaker 42 to generate a sound corresponding to the abnormality determination. Thereafter, the controller 30 executes the process of step S103.

When the process of step S107 is executed, the notification unit 40 issues a notification regarding the determination result of the controller 30 (step S108). In step S108, the notification unit 40 causes the display 41 to display that the determination result of the controller 30 is a normality determination, that is, that the preparation operation has been correctly performed, and causes the speaker 42 to generate a sound corresponding to the normality determination.

When the process of step S108 is executed, the controller 30 ends the preparation determination process.

As shown in FIG. 5, following the preparation determination process, the inspection apparatus 10 executes an assembly sequence determination process to determine whether the operator O has performed the assembly of the components W in the correct sequence (Step S2). The assembling order determination process is executed when the controller 30 determines that the state is normal in step S108 of the preparation determination process.

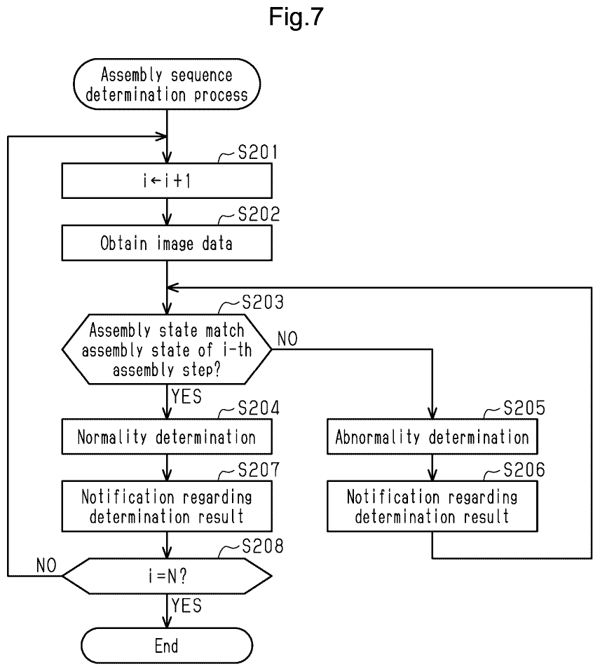

As shown in FIG. 7, in the assembly sequence determination process, the controller 30 increments a counter i by one (S201). The counter i is set to 0 at the start of the assembly sequence determination process.

Next, the controller 30 acquires the image data captured by each camera 21 of the image capturing device 20 (step S202). The controller 30 performs image processing on the image data. As described above, the image capturing device 20 continuously captures images of the work area even after the preparation determination process is ended.

Next, the controller 30 determines whether the assembly state of the components W included in the image data matches the assembly state of the i-th assembly process (step S203). In a case in which the assembly state of the components W matches the assembly state of the i-th assembly step (step S203: YES), the controller 30 determines that the assembly sequence of the components W is normal (step S204). On the other hand, in a case in which the assembly state of the components W does not match the assembly state of the i-th assembly step (step S203: NO), the controller 30 determines that the assembly sequence of the components W is abnormal (step S205).

In the first assembly step of the present embodiment, two collar-integrated grommets 141 are assembled onto the case 110. Therefore, in step S203, the controller 30 determines whether the assembly state of each collar-integrated grommet 141 on the case 110 is a correct assembly state.

In the second assembly step, three clamps 160 are assembled onto the case 110. Therefore, in step S203, the controller 30 determines whether the assembly state of the clamps 160 on the case 110 is a correct assembly state.

In a third assembly step, the filter element 130 is assembled to the case 110. Therefore, in step S203, the controller 30 determines whether the assembly state of the filter element 130 on the case 110 is the correct assembly state.

In a fourth assembly step, the cap 120 is assembled to the case 110. Therefore, in step S203, the controller 30 determines whether the assembly state of the cap 120 on the case 110 is the correct assembly state.

When the process of step S205 is executed, the notification unit 40 issues a notification regarding the determination result of the controller 30 (step S206). In step S206, the notification unit 40 causes the display 41 to display that the determination result of the controller 30 is the abnormality determination, that is, that the assembly sequence of the components W is abnormal, and causes the speaker 42 to generate a sound corresponding to the abnormality determination. Thereafter, the controller 30 executes the process of step S203.

On the other hand, when the process of step S204 is executed, the notification unit 40 issues a notification of the determination result of the controller 30 (step S207). In step S207, the notification unit 40 causes the display 41 to display that the determination result of the controller 30 is a normality determination, that is, that the assembly sequence of the components W is normal, and causes the speaker 42 to generate a sound corresponding to the normality determination.

Next, the controller 30 determines whether the counter i matches a total number N of assembly steps for the manufacturing variant V (step S208). In the present embodiment, the total number N is set to “4.”

If the counter i is equal to the total number N (step S208: YES), the controller 30 ends the assembly sequence determination process. When the counter i does not match the total number N (step S208: NO), the controller 30 executes the process of S201. As a result, the correctness of the assembly state in the next assembly step is determined.

Operation and advantages of the present embodiment will now be described.
(1) The inspection apparatus 10 includes the image capturing device 20 configured to capture images of the work area, and the memory module 32 storing the first learning model M1. The first learning model M1 is trained through machine learning to output, when receiving image data captured by the image capturing device 20, an indicator that indicates whether the assembly state of a component W is a correct assembly state. The inspection apparatus 10 includes the determination unit 33, which is configured to determine whether the assembly state is the correct assembly state for each assembly step based on the output result of the first learning model M1, and the notification unit 40, which is configured to notify the operator O of the determination result of the determination unit 33.

With this configuration, the operator O is notified, for each assembly step, whether the components W have been assembled in the correct assembly state. As a result, the operator O can determine whether the assembly operation is being performed in the correct assembly sequence.

The determination of the assembly state of the components W by the determination unit 33 is based on the output result of the first learning model M1, which has been trained through machine learning. Accordingly, the operator O does not need to place the components W in specific positions or orientations, or temporarily interrupt the operation to facilitate image capturing of the components W for determination. As a result, a decrease in the production efficiency of the product P is suppressed.

In the manufacturing process of the air cleaner 100, once the fourth assembly step is completed, the filter element 130 assembled in the third assembly step is no longer visible from the exterior of the air cleaner 100.

With the above-described configuration, the inspection apparatus 10 determines the correctness of the assembly state of the components W at each assembly step. Therefore, in comparison with a case in which the appearance inspection of the product P is performed after all the assembly steps, it is easy to ensure that the components W positioned inside the product P are in the correct assembly state.
(2) The determination unit 33 is configured to determine that the assembly state of the components W is correct when the output result of the first learning model M1 having received, as input, image data captured by at least one of the cameras 21, is an indicator indicating the correct assembly state.

With this configuration, for the determination unit 33 to determine that the assembly state of the components W is the correct assembly state, it is sufficient for at least one of the cameras 21 to capture an image of the correct assembly state. As a result, the operator O does not need to orient the components W specifically toward a certain image capturing device 20 when performing the assembly process. As a result, a decrease in the production efficiency of the product P is further suppressed.
(3) The determination unit 33 is configured to determine whether the product variant shown on the display section 51 and the manufacturing variant V match based on the image data.

With this configuration, the operator O can determine whether the product variant of the component W stored in each component box 50 matches the manufacturing variant V. As a result, during the preparation operation prior to the assembly operation, the risk of preparing components W of a product variant different from the manufacturing variant V is reduced. Consequently, incorrect assembly of components W of different product variants is reduced.
(4) The determination unit 33 is configured to determine whether the number of the component boxes 50, each having the display section 51 that shows the manufacturing variant V, matches the number of types of the components W that are to be accommodated in the component boxes 50 among components W of multiple types.

This configuration allows the operator O to determine whether the number of the component boxes 50, each including the display section 51 showing the manufacturing variant V, and the number of types of the components W that are to be accommodated in the component boxes 50 match. As a result, the operator O can determine whether the necessary component boxes 50, each containing a different type of component W required for assembling the product P, have been prepared in the correct quantity. This configuration helps prevent missing components W during the assembly of product P.
(5) The memory module 32 stores the second learning model M2, which has been trained through machine learning to output, when receiving image data, an indicator indicating which product variant, among multiple product variants, is shown on the display section 51. The determination unit 33 is configured to determine whether the product variant shown on the display section 51 matches the manufacturing variant V based on the output result of the second learning model M2.

With this configuration, the determination unit 33 determines whether the product variant shown on the display section 51 matches the manufacturing variant V based on the output result of the second learning model M2, which has been trained through machine learning. Therefore, when the determination unit 33 determines the product variant shown on the display section 51, the operator O does not need to arrange the component box 50 at a specific position or orientation, or temporarily interrupt the operation to facilitate image capturing of the component box 50. As a result, this configuration helps maintain work efficiency in the preparation operation of the components W and, ultimately, prevents a decline in the production efficiency of the product P. cl Modifications

The above-described embodiment may be modified as follows. The above-described embodiment and the following modifications can be combined as long as the combined modifications remain technically consistent with each other.

The determination unit 33 may determine whether the product variant shown on the display section 51 matches the manufacturing variant V without using the output result of the second learning model M2. In this case, the determination unit 33 may determine, for example, whether the display section 51, which shows the manufacturing variant V, matches a registered image stored in which a display section 51 showing the manufacturing variant V has been registered.

The determination unit 33 does not necessarily need to determine whether the number of the component boxes 50 matches the number of types of the components W that are to be accommodated in the component boxes 50. That is, the controller 30 may omit the process of step S104. In this case, the notification unit 40 may issue a notification regarding the determination result in step S103. Additionally, the operator O may determine whether the number of the component boxes 50 matches the number of types of the components W that are to be accommodated in the component boxes 50.

The inspection process may be performed without executing the preparation determination process and may instead only execute the assembly sequence determination process. In this case, the operator O may determine whether the product variant shown on the display section 51 matches the manufacturing variant V, and may determine whether the number of the component boxes 50 matches the number of types of the components W that are to be accommodated in the component boxes 50.

The number of the cameras 21 included in the image capturing device 20 may be one or more.

The image capturing device 20 may include a camera 21 fixed to the frame 201 and a camera 21 worn by the operator O. With this configuration, the camera 21 worn by the operator O can recognize components W from the viewpoint of the operator O, thereby improving the accuracy of determining the correctness of the assembly state of the components W.

The positions of the cameras 21 may be changed. For example, cameras 21 may be respectively disposed both above and below a transparent workbench 200. This configuration reduces blind spots for the cameras 21 within the work area.

In the above-described embodiment, the notification unit 40 notifies the operator O of the determination result of the determination unit 33 for each assembly step. Alternatively, the notification unit 40 may issue a notification regarding the determination result of the determination unit 33 after each of multiple assembly steps or only upon completion of the final assembly step.

The notification unit 40 may issue a notification solely via the display 41 or solely via the speaker 42.

The notification unit 40 may also be a wearable device worn by the operator O. In this case, the wearable device preferably issues a notification regarding the determination result of the determination unit 33 by displaying the determination result on a screen or by generating sound, light, vibration, or the like.

The determination unit 33 may determine the correctness of the assembly state at the (i+1)th assembly step while simultaneously determining that the correct assembly state from the i-th assembly step has been maintained.

The first learning model M1 may be trained through machine training using training data in which images of components W that are not assembled in the correct assembly state are labeled with information indicating that the assembly state is not correct. In this case, the determination unit 33 may determine that the assembly state is the correct assembly state when the probability that the assembly state of the components W is not the correct assembly state is less than or equal to the threshold. The first learning model M1 may be obtained through machine learning using both this training data and the training data according to the above-described embodiment.

The inspection apparatus 10 may start the assembly sequence determination process when it is determined that a target component W, such as a case 110 onto which other components W are to be assembled, is present within the work area.

After the assembly of the product P is completed, the determination unit 33 may determine whether a completion stamp indicating the completion of the assembly step has been affixed to the product P. The notification unit 40 may then notify the operator O of the determination result of the determination unit 33.

The notification unit 40 may be configured to selectively issue a notification regarding whether the determination result of the controller 30 is an abnormality determination. In a preferred example of the inspection apparatus 10 to which the notification unit 40 according to this modification is applied, the controller 30 determines the correctness of the assembly state of the components W that have undergone assembly processes up to the (i+1)th assembly step, evaluating whether the assembly states in all the assembly steps, including those up to the (i+1)th step, are correct. In this case, when the controller 30 determines the correctness of the assembly state in the i-th or earlier assembly step, even if it is determined that the assembly state is the correct assembly state in the subsequent assembly process, the notification unit 40 does not necessarily need to issue a notification regarding the abnormality determination.

At least one of the control unit 31, the memory module 32, and the determination unit 33 may be formed by a separate device independent from the others. For example, the controller 30 may be formed by one device that includes the control unit 31 and the memory module 32 and another device that includes the determination unit 33.

The controller 30 can be circuitry including one or more processors that perform various processes according to computer programs (software). The controller 30 may be circuitry including one or more dedicated hardware circuits such as application specific integrated circuits (ASIC) that execute at least part of various processes, or a combination thereof. Each processor includes a CPU and a memory such as a RAM and a ROM. The memory stores program codes or instructions configured to cause the CPU to execute processes. The memory, which is a computer-readable medium, includes any type of media that are accessible by general-purpose computers and dedicated computers.

1-5. (canceled)

6. An inspection apparatus configured to inspect a sequence of operations during manufacturing of a product that is manufactured by an operator assembling multiple types of components, the inspection apparatus comprising:
an image capturing device including multiple cameras configured to capture images of a work area, in which the components are assembled, from angles different from each other;
a memory module storing a learning model that is trained through machine learning to output, when receiving image data captured by the image capturing device, an indicator that indicates whether an assembly state of the components is a correct assembly state;
circuitry configured to determine whether the assembly state is the correct assembly state for each assembly step based on an output result of the learning model; and
a notification unit configured to notify the operator of a determination result of the circuitry for each assembly step.

7. The inspection apparatus according to claim 6, wherein
the circuitry is configured such that, in a case in which an indicator indicating that the assembly state is the correct assembly state is output as an output result of the learning model corresponding to input of the image data captured by at least one of the multiple cameras, the circuitry determines, based on the output result, that the assembly state is the correct assembly state.

8. The inspection apparatus according to claim 6, wherein
at least one type of component among the multiple types of components is accommodated in a component box having a display section that shows information related to a variant of the product, and is taken out from the component box and assembled by the operator, and
the circuitry is configured to determine, based on the image data, whether the product variant shown on the display section matches a manufacturing variant that is a variant of the product being manufactured by the operator.

9. The inspection apparatus according to claim 8, wherein
the component box is one of multiple component boxes, at least two types of components among the multiple types of components are separately accommodated in different ones of the component boxes, and are respectively taken out from the component boxes and assembled by the operator, and
the circuitry is configured to determine whether a number of the component boxes, each having the display section that shows the manufacturing variant, matches a number of types of components that are to be accommodated in the component boxes among the components of the multiple types.

10. The inspection apparatus according to claim 8, wherein
the learning model is a first learning model,
the memory module stores a second learning model trained through machine learning to output, when receiving the image data, an indicator that indicates which one of the multiple product variants is shown on the display section, and
the circuitry is configured to determine whether the product variant shown on the display section and the manufacturing variant match based on an output result of the second learning model.
